(19) United States
(12) Patent Application Publication
(10) Pub. No.: US 2024/0232876 A9
(43) Pub. Date: Jul. 11, 2024

(54) METHOD FOR PROCESSING BLACKLIST-BASED TRANSACTION AND RELATED APPARATUS

(71) Applicant: Yuefei Tan, Guangzhou (CN)

(72) Inventor: Yuefei Tan, Guangzhou (CN)

(21) Appl. No.: 17/972,888

(22) Filed: Oct. 25, 2022

(51) Int. Cl. G06Q 20/38; G06Q 20/06; G06Q 20/22

(52) U.S. Cl. CPC G06Q 20/389; G06Q 20/065; G06Q 20/223

(57) ABSTRACT

The present invention discloses a method for processing a blacklist-based transaction and a related apparatus. The method includes the following steps: taking blacklist information, parsing the blacklist information, and obtaining a plurality of blacklisted addresses; retrieving a preset transaction record according to an address in the blacklist and a preset local address, and obtaining a processed record; calculating the sum of all the transaction amounts of the processed records for the preset local address, and obtaining a blacklisting amount; announcing and destroying the blacklisting amount by initiating a destroying transaction, and saving the destroying transaction's record. When a transaction that is sent in bad faith is provided, the present invention may be used to actively destroy the transaction's amount and announce to avoid triggering an alarm mechanism.

### TECHNICAL FIELD

The present invention relates to the technical field of a blockchain, and particularly to a method for processing a blacklist-based transaction and a related apparatus.

### BACKGROUND

Tornado Cash is an open source application (App) that runs on a public blockchain platform with smart contract functions. Tornado Cash is well concealed and has been popular among people who want to hide their Blockchain trading information. When a user sends a transaction with ETHs to Tornado Cash, Tornado Cash will perform operations to send these ETHs to the transaction's intended receiver but make the sender's address completely irrelevant to the receiver's address. For example, if A directly transfers ETHs to B in a regular Ethereum transaction, thanks to Ethereum's data transparency, all the nodes of Ethereum can publicly access all the details of this transfer and query that A has transferred a certain quantity of ETHs to B. However if A uses Tornado Cash to make this transfer, all the Ethereum nodes can see is that Tornado Cash makes a transfer to B, and with regard to whom Tornado Cash receives this amount from is unknown. This feature perfectly prevents a sender's address from being publicly accessible. And it also makes it difficult to use Ethereum's existing data transparency feature to search and trace a transaction's true history and origin.

However, this feature is easily linked to a financial crime such as money-laundering. This privacy is used by an ordinary user to conceal an address thereof as a sender in a transfer transaction while being also used by a large number of criminals for money laundering, making it difficult for a regulator to trace an origin of “stolen money”. Tornado Cash, for example, has smart contracts deployed on Ethereum, as well as addresses with which there are transactions involving cyber money laundering and financial crimes, and which have been added to a SDN list (Specially Designated Nationals and Blocked Persons List). However, such a transfer also makes it difficult for regulators to determine the nature of a transaction due to the limitation of Ethereum's technology mentioned in the prior art. An alternative example is: when User A sends a transaction to B using Tornado Cash, User A may only see that Tornado Cash sends the transaction to B from an Ethereum explorer. But it is impossible for User A to tell whether the transaction sent by Tornado Cash to B is a financial transaction involving a crime or money laundering, or a legitimate transaction made by a regular user who uses Tornado Cash simply to protect the privacy of the sender's address. However, when an address is added to the SDN list, a transaction with the address can easily trigger an alarm mechanism. To that end, actors can maliciously use Tornado Cash to send a transaction with a small amount to an Ethereum address held by an innocent individual, triggering an alarm for the innocent individual.

### SUMMARY

The technical problem to be solved by the present invention is that an Ethereum address involved in a malicious transaction raises an alarm. For the shortcomings of the prior art, the present invention provides a method for processing a blacklist-based transaction and a related apparatus.

In order to solve the above technical problem, the present invention adopts the following technical solution:
a method for processing a blacklist-based transaction includes the following steps:
obtaining the blacklist information, parsing the blacklist information, and obtaining a plurality of blacklisted addresses;
retrieving a preset transaction record according to a blacklisted address in the blacklist and a preset local address, and obtaining a processed record;
calculating the sum of all transaction amounts of the processed records, and obtaining a blacklisting amount; and
announcing and destroying the blacklisting amount by initiating a destroying transaction and saving the transaction's record.

For the method for processing the blacklist-based transaction, the blacklist information includes a blacklist webpage. The steps of obtaining the blacklist information, parsing the blacklist information, and obtaining the plurality of blacklist addresses include:
obtaining the blacklist webpage; and
according to a preset filtering rule, traversing the blacklist webpage, and obtaining the blacklisted addresses on the blacklist webpage.

For the method for processing the blacklist-based transaction, the step of retrieving a preset transaction record according to a blacklisted address in the blacklist and a preset local address, and obtaining a processed record includes:
when a blacklisted address is parsed and obtained, retrieving a preset transaction record according to the blacklisted address, and obtaining a processed record.

For the method for processing the blacklist-based transaction, the step of retrieving a preset transaction record according to the blacklisted address and a preset local address, and obtaining a processed record includes:
taking the blacklisted address as a sending address, taking the local address as a receiving address, taking the timestamp when the blacklist is generated as a starting time, taking the timestamp when a preset query is executed as an end time, and generating a set of retrieving parameters; and
retrieving a transaction record according to the set of retrieving parameters, and obtaining a processed record.

For the method for processing the blacklist-based transaction, the step of calculating the sum of all transaction amounts of all the processed records, and obtaining a blacklisting amount include:
for each of the processed records, parsing the processed record and obtaining the plurality of transaction amounts;
calculating the sum of all the transaction amounts of the processed records and obtaining a processed amount; and
summing the processed amounts of all the processed records and obtaining a blacklisting amount.

For the method for processing the blacklist-based transaction, the step of announcing and destroying the blacklisting amount by initiating a destroying transaction and saving the transaction's record include:
generating the destroying data based on the blacklisting amount and preset announced information;
sending a destroying transaction with the destroying data to a preset destroying address on Ethereum; and
when a confirmation for the destroying transaction is generated by the Ethereum blockchain and is detected, saving the destroying data as the destroying record.

For the method for processing the blacklist-based transaction, the step of generating the destroying data based on the blacklisting amount and the preset announced information includes:
converting the preset announced information and obtaining an announced character string;
determining the destroying amount in the destroying data according to the blacklisting amount; and
using the announced character string as memo information for the destroying amount, and generating the destroying data according to the memo information and the destroying amount.

A device for processing a blacklist-based transaction includes:
an obtaining module configured to obtain the blacklist information, parse the blacklist information, and obtain a plurality of blacklist addresses;
a retrieving module configured to retrieve a preset transaction record according to a blacklisted address in the blacklist and a preset local address, and obtain a processed record; and
a calculating module configured to calculate the sum of all transaction amounts of the processed records, and obtain a blacklisting amount; and
a destroying module configured to announce and destroy the blacklisting amount and save a destroying transaction's record.

A computer-readable storage medium is stored with one or more programs. One or more programs are capable of being executed by one or more processors to implement the steps in the above method for processing the blacklist-based transaction.

A terminal apparatus includes a processor, a memory, and a communication bus. The memory is stored with a computer-readable program executable by the processor.

The communication bus enables connected communication between the processor and the memory;

The processor implements the steps of the above method for processing the blacklist-based transaction when executing the computer-readable programs.

Beneficial effects: the present invention provides a method for processing a blacklist-based transaction and a related apparatus. The blacklist information is firstly obtained. The blacklist information includes a plurality of blacklisted addresses. According to the blacklisted addresses, a transaction between an address and a blacklisted address in the blacklist is retrieved. The retrieved transaction record is taken as a processed record that needs to be processed. Then, all the amounts that the address receives from all the blacklisted addresses in the blacklist based on all the processed records, that is, a blacklisting amount, are calculated. Finally, based on the characteristics of an announcement broadcasted on Ethereum, the blacklisting amount is destroyed. All the nodes on Ethereum can receive the notification of the destroying transaction for this address. After the blacklisting amount is destroyed successfully, a destroying transaction's record is saved for all the nodes on Ethereum, and can be used as an evidence/a deposit certificate for subsequent appeals. In this self-proving innocence way, even if a transaction is maliciously sent by a blacklisted address, an alarm mechanism can be avoided from being triggered and the address can still work normally.

### BRIEF DESCRIPTION OF THE DRAWINGS

FIG. 1 is a flow diagram of a method for processing a blacklist-based transaction provided by the present invention.

FIG. 2 is a schematic diagram of a device for processing a blacklist-based transaction provided by the present invention.

FIG. 3 is a structural schematic diagram of a terminal apparatus provided by the present invention.

### DETAILED DESCRIPTION OF EMBODIMENTS

The present invention provides a method for processing a blacklist-based transaction. In order to make the objective, technical solution and effect of the present invention clearer, the present invention is described in further details below with reference to the accompanying drawings and examples. It should be understood that the specific examples described herein are only used to explain the present invention, but not to limit the present invention.

Those skilled in the art may understand that singular forms “a,” “an,” “the” and “this” used herein may also include plural forms unless specifically stated. It is further understood that a term “comprising” as used in the specification of the present invention refers to the presence of such features, integers, steps, operations, elements and/or assemblies, but does not preclude the presence or addition of one or more other features, integers, steps, operations, elements, components and/or groups thereof. It should be understood that when an element is “connected” or “coupled” to another element, the element may be directly connected or coupled to another element, or an intermediate element can be provided. Further, the “connection” or “coupling” used herein may include a wireless connection or a wireless coupling. A term “and/or” as used herein includes all or any unit and all combinations of one or more associated list items.

Those skilled in the art may understand that unless defined otherwise, all terms used herein, including technical and scientific terms, have the same meaning as commonly understood by those skilled in the art to which this invention belongs. It should also be understood that terms such as those defined in a general dictionary are to be understood as having a meaning consistent with those in the context of the prior art and are not to be interpreted in an idealized or overly formal sense unless specifically defined here.

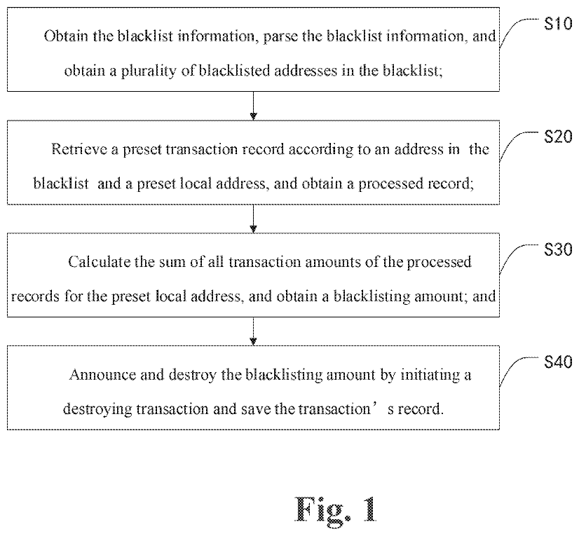

As shown in FIG. 1, an embodiment provides a method for processing a blacklist-based transaction. For convenience of explanation, a common server is described as an executing subject. The server here can be replaced with a tablet, a computer or other devices having a data processing function. The method for processing the blacklist-based transaction includes the following steps:

S10, obtaining blacklist information, parsing the blacklist information, and obtaining a plurality of blacklisted addresses.

Specifically, the blacklist information may include webpages obtained from various published websites, a list for storing a blacklisted address, and the like.

Taking the blacklist information of an SDN list as an example, the SDN list may be downloaded from a website published on the SDN list at regular intervals. The SDN list contains a plurality of different types of sanctioned targets, and contains not only a blacklist on the Ethereum blockchain, but also blacklists on other blockchains as well, so the information that does not belong to the Ethereum blockchain needs to be filtered. In the SDN list, an Ethereum address starts with “0x“and ends with”;”. A filtering rule is generated based on the characteristics of a legitimate Ethereum address. such as a filtering rule in the form of a regular rule. A blacklist page is then traversed according to the filtering rule, and the blacklisted addresses on the blacklist page are filtered. In this example, n blacklisted addresses are provided and are denoted as Address₁, . . . , Addressₙ, respectively

Besides parsing a webpage, the blacklist information may be obtained via an interface of a database used to store the blacklisted addresses as well. The blacklist information is obtained in advance from relevant forums and uploaded locally for parsing.

S20, retrieving a preset transaction record according to a blacklisted address in the blacklist and a preset local address, and obtaining a processed record.

Specifically, each node of the Ethereum blockchain has all the accounts' information. When a transaction is made by an address held by a user on Ethereum, each node stores that transaction record locally in itself, ensuring the transaction's data is tamper-proof and publicly verifiable. Thus, in the node where the user's address is generated, the record of each transaction involving the user's address is stored.

With regard to a transaction sent from a blacklisted address, the blacklisted address is the initiating address and its receiving address is a local address. The transaction is retrieved, and the corresponding transaction is obtained. The transaction is named as the processed record. In this example, the total number of the transaction records is m, and the processed records can be recorded as InternalTxns₁, InternalTxns₂, . . . , InternalTxnsₘ.

Further, in the parsing process, all the blacklisted addresses are parsed one by one, rather than simultaneously. Therefore, to improve processing efficiency, when a blacklisted address is parsed and obtained, a preset transaction record for the blacklisted address is retrieved, and a processed record is obtained. Asynchronous processing between these different blacklisted addresses is implemented to improve processing efficiency.

Further, a later-on blacklisted address was not initially included in the blacklist. When the address was initially used, it executed legitimate transactions. Therefore, in order to clearly define a malicious transaction initiated by the address, the timestamp when the address is included in the blacklist is also taken into consideration when retrieving. For a transaction sent by a blacklisted address, the blacklisted address is taken as the sending address, the local address that receives the transaction is taken as the receiving address. The timestamp when the blacklist is generated is taken as the starting time. The timestamp when a preset query is executed is taken as the end time. A set of retrieving parameters therefore are obtained. The transaction is retrieved to obtain a processed record. When a blacklist is published on a webpage, the time of publication is taken as the starting time. When a blacklist is a list of database records, the time of generation of the list is taken as the starting time. The timestamp when a query is executed or a timestamp defined by the user is taken as the end time.

S30, calculating the sum of all transaction amounts of all the processed records, and obtaining a blacklisting amount.

Specifically, each processed record is sourced from a blacklisted address, so in order to prove innocence, it is necessary to count all transaction amounts sourced from all the blacklisted addresses. Each processed record is parsed to obtain the corresponding transaction amount, and then the sum of all the transaction amounts is calculated to obtain a blacklisting amount.

When a processing order is parsed, the plurality of transaction amounts in the processing order can be obtained by Web3.js and so on. For each processing order, the processed record is parsed to obtain the plurality of transaction amounts. For example, in this example, a total of m₁Values are read, which are denoted as Value₁, Value₂, . . . , Valueₘ_{₁}, respectively. Then, the sum of the transaction amounts of the processed record is calculated to obtain a processed amount. The processed amounts corresponding to all the processed records are summed to obtain a blacklisting amount. A calculation formula may be:

$${V}_{total} = {\sum }_{\dot{ι} = 1}^{i = n} ( {\sum }_{j = 1}^{j = {m}_{i}} {Value}_{j} )$$

Vₜₒₜₐₗ is the blacklisting amount.

S40, announcing and destroying the blacklisting amount and saving a destroying transaction's record.

Specifically, after the blacklisting amount is obtained, a certain quantity of Ethers worth equivalent to the blacklisting amount is destroyed. Based on the transparency feature of Ethereum transactions, a process of destroying the blacklisting amount is publicly verifiable, so that each node of the Ethereum blockchain can witness the destroying transaction and record the process of destroying the blacklisting amount. Each node also saves the corresponding destroying transaction's record locally. Subsequently, by relying on a record saved by each node, any node can prove innocence thereof and avoid account usage from being affected by transactions sent by any of the blacklisted addresses. The hash value “T×n Hash” generated by the transaction is recorded as the destroying record when the destroying record is saved.

On Ethereum, a blacklisting amount can be used as a transaction amount, and the destroying address of Ethereum (also known as a “dead address”) “0x0000000000000000000000000000000000000000” can be used as a transaction object i.e. a receiving address. The blacklisting amount may be destroyed by sending the blacklisting amount to the dead address.

However, if a blacklisting amount is simply destroyed in a transaction without a public announcement, it will be difficult to search for the transaction by tracing the transaction's record back to its source, and it, as well, will be difficult to prove that the transaction is done to prove the innocence thereof, rather than a regular transaction. Accordingly, in this example, a piece of announced information is set in advance, and the announced information is used to indicate that the objective of the destroying transaction is to show that the sender of the destroying transaction didn't have intentions to interact with the blacklisted addresses. For example, the announced information used is “I am not aware of the ETHs I received from Tornado Cash. Hence I am sending the ETHs to the zero address”. The data for the destroying transaction is then generated based on the blacklisting amount and the announced information. The data is then sent to the destroying address on Ethereum. When the destroying address receives the destroying data, Ethereum will generate a confirmation for this transaction and all Ethereum nodes will be publicly able to access this confirmation, the destroying data is taken as the destroying record and saved locally on each Ethereum node. At the same time, based on the characteristics of Ethereum, both sending the destroying transaction's data and generating the confirmation by Ethereum can be publicly witnessed by every node of the Ethereum blockchain, and the destroying data is stored locally on every node. In case of subsequent self-proving innocence, the information can be more easily retrieved according to the announced information, and the validity of proving can be enhanced. When the destroying data is generated, to improve security, the announced information may first be converted to a character string, for example, a hexadecimal character string. Additionally, the destroying amount that needs to be destroyed in the future is determined on the basis of the blacklisting amount. Finally, the announced character string is used as memo information for the destroying amount. The destroying data is generated according to the memo information and the destroying amount. The destroying transaction is initiated as a regular Ethereum transaction, and is therefore not stated separately.

Further, a process of destroying the blacklisting amount can be automated. A notification can be pushed to a terminal of the user to confirm the destroying transaction. The user can initiate a destroying transaction on an initiative thereof, and so on. Before the blacklisting amount is destroyed, check the account's balance. When the account's balance is greater than or equal to the blacklisting amount, the blacklisting amount can be destroyed. When the account's balance is less than the blacklisting amount, a preset reminder will be sent to the user, so that the user can decide whether or not to add additional Ethers to his/her address before initiating a destroying transaction.

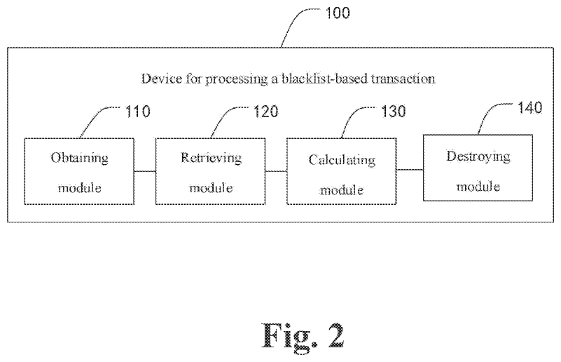

As shown in FIG. 2, the present invention further provides a device 100 for processing a blacklist-based transaction, including:
an obtaining module 110 configured to obtain blacklist information, parse the blacklist information, and obtain a plurality of blacklist addresses;
a retrieving module 120 configured to retrieve a preset transaction record according to a blacklisted address in the blacklist and a preset local address, and obtain a processed record;
a calculating module 130 configured to calculate the sum of all transaction amounts of the processed records, and obtain a blacklisting amount; and
a destroying module 140 configured to announce and destroy the blacklisting amount and save a destroying transaction's record.

The blacklist information includes a blacklist webpage. The obtaining module 110 is specifically applied to:
obtain the blacklist webpage; and
according to a preset filtering rule, traverse the blacklist webpage, and obtain the blacklisted addresses on the blacklist webpage.

The retrieving module 120 includes an asynchronous retrieving unit. The asynchronous retrieving unit retrieves a preset transaction record according to a blacklisted address in the blacklist when the blacklisted address is parsed, and obtains a processed record.
the asynchronous retrieving unit is specifically configured to:
take a blacklisted address as a sending address, take a local address as a receiving address, take the timestamp when the blacklist is generated as a starting time, take the timestamp when a preset query is executed as an end time, and obtain a set of retrieving parameters; and
retrieve a transaction record according to the set of retrieving parameters, and obtain a processed record.

The calculating module 130 includes:
a parsing unit configured to parse a processed record for each of the processed records and obtain the plurality of transaction amounts;
a calculating unit configured to calculate the sum of all the transaction amounts of the processed record and obtain a processed amount; and
a summing unit configured to sum the processing amounts of all the processed records to obtain a blacklisting amount.

The destroying module 140 includes:
a generating unit configured to generate a destroying data based on the blacklisting amount and a piece of preset announced information;
a sending unit configured to send a destroying transaction with the destroying data to a preset dead address on Ethereum; and
a holding unit configured to take the destroying data as the destroying record and save the destroying data when a confirmation for the destroying transaction is generated by Ethereum and is detected.

The generating unit is specifically configured to:
convert the preset announced information and obtain an announced character string;
determine the destroying amount in the destroying data according to the blacklisting amount; and
use the announced character string as memo information for the destroying amount, and generate the destroying data according to the memo information and the destroying amount.

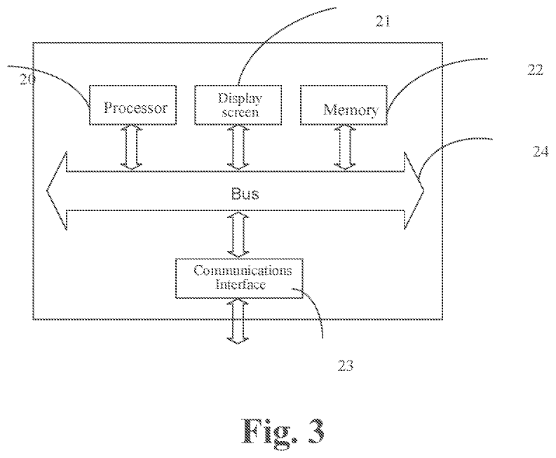

Based on the method for processing a blacklist-based transaction described above, the present invention also provides a terminal apparatus. As shown in FIG. 3, the terminal apparatus includes at least one processor 20, a display screen 21, and a memory 22, and may further include a communications interface 23 and a bus 24. The processor 20, the display screen 21, the memory 22, and the communications interface 23 may complete communication with each other via the bus 24. The display screen 21 is configured to display a user guidance interface preset in an initial setting mode. The communications interface 23 may transmit information. The processor 20 may invoke logic instructions in the memory 22 to perform the methods in the example described above.

Furthermore, the logical instructions in the memory 22 described above may be implemented in a form of a software functional unit and may be stored in a computer-readable storage medium when being sold or used as a stand-alone product.

The memory 22, as the computer-readable storage medium, may be configured to store software programs and computer-executable programs, such as program instructions or a module corresponding to the method in the example of the present invention. The processor 20 executes functional applications as well as data processing by running software programs, instructions, or modules stored in the memory 22, i.e., implementing the method in the example described above.

The memory 22 may include a storage program region and a storage data region. The storage program region may store an operating system and at least one functionally required application. The storage data region may store data created based on use of the terminal apparatus, and the like. In addition, the memory 22 may include a high-speed random access memory and may also include a non-volatile memory. For example, a variety of media such as a USB drive, a mobile hard disk, a Read-Only Memory (ROM), a Random Access Memory (RAM), a diskette, or an optical disk, etc., that may store program code, may be a transient computer-readable storage medium.

Furthermore, a specific process that a plurality of instructions in the computer-readable storage medium are loaded and executed by the processor and the terminal apparatus is described in detail in the method described above, and will not be described here individually.

Finally, it should be noted that the foregoing examples are intended for describing instead of limiting the technical solutions of the present invention. Although the present invention is described in detail with reference to the foregoing examples, those skilled in the art should understand that they may still make modifications to the technical solutions described in the foregoing examples or make equivalent replacements to some technical features thereof, without departing from the spirit and scope of the technical solutions.

1. A method for processing a blacklist-based transaction, comprising the following steps:
obtaining the blacklist information, parsing the blacklist information, and obtaining a plurality of blacklisted addresses in the blacklist;
retrieving a preset transaction record according to an address in the blacklist and a preset local address, and obtaining a processed record;
calculating the sum of all transaction amounts of the processed records for the preset local address, and obtaining a blacklisting amount; and
announcing and destroying the blacklisting amount by initiating a destroying transaction and saving the transaction's record.

2. The method for processing the blacklist-based transaction according to claim 1, wherein the blacklist information comprises a blacklist webpage; and the step of obtaining the blacklist information, parsing the blacklist information, and obtaining the plurality of blacklisted addresses comprises:
obtaining the blacklist webpage;
according to a preset filtering rule, traversing the blacklist webpage, and obtaining the blacklisted addresses on the blacklist webpage.

3. The method for processing the blacklist-based transaction according to claim 4, wherein the step of retrieving a preset transaction record according to an address in the blacklist and a preset local address, and obtaining a processed record comprises:
when a blacklisted address is parsed and obtained, retrieving the preset transaction record according to the blacklisted address, and obtaining a processed record.

4. The method for processing the blacklist-based transaction according to claim 2, wherein the step of retrieving the preset transaction record according to the blacklisted address and the preset local address, and obtaining the processed record comprises:
taking the blacklisted address as a sending address, taking the local address as a receiving address, taking the timestamp when the blacklist is generated as a starting time, taking the timestamp when a preset query is executed as an end time, and generating a set of retrieving parameters;
retrieving a transaction record according to the set of retrieving parameters, and obtaining the processed record.

5. The method for processing the blacklist-based transaction according to claim 1, wherein the step of calculating the sum of all transaction amounts of the processed records and obtaining a blacklisting amount comprises:
for each of the processed records, parsing the processed record and obtaining the plurality of transaction amounts;
calculating the sum of all the transaction amounts of the processed record and obtaining a processed amount;
summing the processed amounts of all the processed records and obtaining a blacklisting amount.

6. The method for processing the blacklist-based transaction according to claim 1, wherein the step of announcing and destroying the blacklisting amount by initiating a destroying transaction and saving the transaction's record comprises:
generating the destroying data based on the blacklisting amount and preset announced information;
sending a destroying transaction with the destroying data to a preset destroying address on the Ethereum blockchain;
when a confirmation for the destroying transaction is generated by the Ethereum blockchain and is detected, saving the destroying transaction's data as the transaction's record.

7. The method for processing the blacklist-based transaction according to claim 2, wherein the step of generating the destroying transaction's data based on the blacklisting amount and the preset announced information comprises:
converting the preset announced information and obtaining an announced character string;
determining the destroying amount in the destroying data according to the blacklisting amount;
using the announced character string as memo information for the destroying amount, and generating the destroying data according to the memo information and the destroying amount.

8. A device for processing a blacklist-based transaction, comprising:
an obtaining module configured to obtain the blacklist information, parse the blacklist information, and obtain a plurality of blacklisted addresses;
a retrieving module configured to retrieve a preset transaction record according to a blacklisted address and a preset local address, and obtain a processed record;
a calculating module configured to calculate the sum of all transaction amounts of the processed records, and obtain a blacklisting amount;
a destroying module configured to announce and destroy the blacklisting amount and save a destroying transaction's record.

9. A computer-readable storage medium, wherein the computer-readable storage medium is stored with one or more programs, the one or more programs are capable of being executed by one or more processors to implement the steps in the method for processing the blacklist-based transaction according to claim 1.

10. A terminal apparatus, comprising: a processor, a memory, and a communication bus; wherein the memory is stored with a computer-readable program executable by the processor;
the communication bus enables connected communication between the processor and the memory;
the processor implements the steps of the method for processing the blacklist-based transaction of claim 1 when executing the computer-readable program.
